(19) United States
(12) Patent Application Publication
(10) Pub. No.: US 2006/0240819 A1
(43) Pub. Date: Oct. 26, 2006

(54) Method and system for providing mobile number portability between different wireless networks of different technologies

(76) Inventors: Jianming Xu, Plano, TX (US); Ghassan Naim, Garland, TX (US)

Correspondence Address: ALCATEL USA;INTELLECTUAL PROPERTY DEPARTMENT, 3400 W. PLANO PARKWAY, MS LEGL2, PLANO, TX, 75075, US

(21) Appl. No.: 10/503,292

(22) PCT Filed: Feb. 7, 2003
(86) PCT No.: PCT/US03/03742

§ 371 Date: Feb. 22, 2005

Related U.S. Application Data
(60) Provisional application No. 60/355,285, filed on Feb. 8, 2002.

(51) Int. Cl. H04Q 7/20

(52) U.S. Cl. 455/432.1; 455/433

(57) ABSTRACT

An economical method and system is disclosed for supporting seamless mobile number portability between different wireless networks of different technologies without introducing changes to existing network entities in the wireless networks involved in the service.

### BACKGROUND OF THE INVENTION

The present disclosure relates generally to voice and data communications, and more particularly, to a wireless system and method for providing mobile number portability between two different networks such as a Time Division Multiple Access (TDMA) and Global System for Mobile communications (GSM) networks.

With the ever-evolving technology in the wireless industry, new wireless generations are being standardized to provide new and broader set of wireless services to end-users. With this natural evolution, new network architectures and technologies are defined and deployed in the market leading to a coexistence of multiple wireless networks built on multiple technologies with some of them having the capability to support more services than others. In general, older networks may evolve but would never be able to provide the same features or support the same capacity as newer networks.

A subscriber in a given network may decide to change his subscription to another network of different technology. Reasons to do so are many, and some of them are to have access to new service features, better service quality, a wider coverage area at the national and international level. One problem arises when changing subscription to a new network of different technology is that the mobile subscriber must be assigned with a new mobile phone number that will be registered in the new network, therefore will lose his previously number in the old network. This will cause problems such as being unreachable by people who still have the older number as the contact number, which can significantly affect business as well as personal relations.

Mobile number portability is a concept used in wireless systems to resolve the above problem and keep the old number assigned to the same subscriber after changing his subscription options to become a subscriber in a different network owned by the same network operator but of a different technology.

From the perspective of network operators, while operating both an older network and a new network, one of the concerns is how to introduce the mobile number portability solution efficiently and without changing service quality, and introduce minimal change to their existing network architecture and infrastructure.

What is needed, therefore, is a method and system that allows seamless mobile number portability between different wireless networks of different technologies.

### SUMMARY OF THE INVENTION

Responding to the needs for providing an optimum solution for mobile number portability, the present disclosure discloses a system and method to provide number portability between several wireless networks that are of different technologies. Effectively, the present disclosure provides a method and system to interconnect a wireless user from one network type to another based on the mobile identification number. The present disclosure further provides a method and system to route incoming calls from any network with destination to a mobile with a ported number operating in the same or a different network (other than the calling number network). The present disclosure also provides a method and system to route outgoing calls to any network from a mobile with a ported number operating in the same or different network.

In one example, a special network messaging and routing device (NMRD) is used as a network entity to link both networks TDMA and GSM to provide number portability services for both networks. The NMRD will serve mobiles with TDMA ported number that have changed their subscription from TDMA to GSM, and mobiles with GSM ported numbers that have changed their subscription from GSM to TDMA.

By maintaining a database located in the NMRD, all calls arriving to the MTX, MSC and GMSC will trigger a query to the NMRD for information on routing the call. After consulting with its local database, depending on whether the called number is a ported number or not, the NMRD will find the serving MTX, MSC or GMSC after querying HLR and reply to the requesting MTX, MSC or GMSC with the appropriate call routing information.

The method and system disclosed is cost effective because it does not introduce any changes to existing network entities in all wireless networks involved in the service. This is a significant advantage for a network operator or service provider given that there is no need for investing in upgrading existing equipment, and the migration of the services to be supported by the new network can be achieved in much shorter time and at a lower cost. In addition, it requires a minimal number of messaging between core network entities hence reducing the call setup delay.

### BRIEF DESCRIPTION OF THE DRAWINGS

FIG. 1 illustrates a conventional network architecture for providing mobile number portability between a TDMA/IS-41 and a GSM/UMTS network.

FIG. 2 illustrates a service example operation with number portability service in a conventional network architecture, wherein a PSTN number is dialing a GSM mobile that has a TDMA ported number.

FIGS. 3 illustrates the network architecture using one embodiment network messaging and routing device (NMRD) to provide mobile number portability between a TDMA/IS-41 and a GSM/UMTS network according to the present disclosure.

FIG. 4 illustrates a service example operation with number portability service in a network architecture using the NMRD wherein a PSTN number is dialing a GSM mobile that has a TDMA ported number.

FIG. 5 illustrates a service example operation with number portability service in a network architecture using one embodiment of the NMRD wherein a PSTN number is dialing a TDMA mobile that has a GSM ported number.

FIG. 6 illustrates a service example operation with number portability service in a network architecture using NMRD wherein a GSM Message center is sending an SMS message to a TDMA mobile with a GSM ported number.

FIG. 7 illustrates one embodiment of a process flow used by the NMRD.

### DESCRIPTION OF THE PREFERRED EMBODIMENT

For the purposes of illustrating the present disclosure, various acronyms are used, and the definitions of which are listed below:
ANM ANswer Message
ANSI41 American National Standards Institute—Cellular Radio Telecommunications Intersystem Operations
BSS Base Station System
DN Dialled Number
GMSC Gateway MSC
GSM Global System for Mobile communications
HLR Home Location Register
IAM Initial Address Message
IS41 Wireless Network conforming to the IS41 standard
ISUP ISDN User Part (of SS7)
LocReq Location Request
LocReqResp Location Request Response
MAP Mobile Application Part
MC Message Center
MSC Mobile Switching Center
MSRN Mobile Switching Routing Number
MTX Mobile Telephone Exchange—A term used to describe a large exchange used within a cellular mobile system and connected to the PSTN.
NMRD Network Messaging and Routing Device
PRN Provide Routing Number
PRNResp PRN Response
PSTN Public Switch Telephone Network
SMS Short Message Service
SMSC Short Message Service Center
SRI Send Routing Information
SRIResp SRI Response
SS7 Signaling System No.7
T1 Digital communication line that uses time division multiplexing with an overall transmission rate of 1.544 million bits per second.
UMTS Universal Mobile Telecommunications System
USSD Unstructured Supplementary Service Data

The present disclosure described below uses several examples. It is understood, however, that the examples are not necessarily limitations, but are used to describe typical embodiments for illustrative purposes. For instance, although TDMA/IS41 and GSM networks are used as example networks, the same concept can be applied to UMTS, and CDMA wireless networks. Additionally, although two networks are discussed, it is contemplated that more than two networks of different technologies can be used. For instance, the method and system disclosed applies to a scenario where three different networks of three different technologies, and a mobile has a ported number from all networks (e.g., from TDMA to GSM to CDMA network). In addition, even though voice service and short message service (“SMS”) are used for illustration, the present disclosure contemplates other services such as Unstructured Supplementary Service Data (USSD) services. Furthermore, although a network messaging and routing device referenced as the “NMRD” is shown connected to one mobile switching center (“MSC”), one gateway MSC (“GMSC”), one mobile telephone exchange (“MTX”) and one home location register (“HLR”). However, the NMRD can be connected to multiple MSC, GMSC, MTX and HLR entities. In addition, the system and method of the present disclosure can work with mobiles that do not have ported numbers from another network.

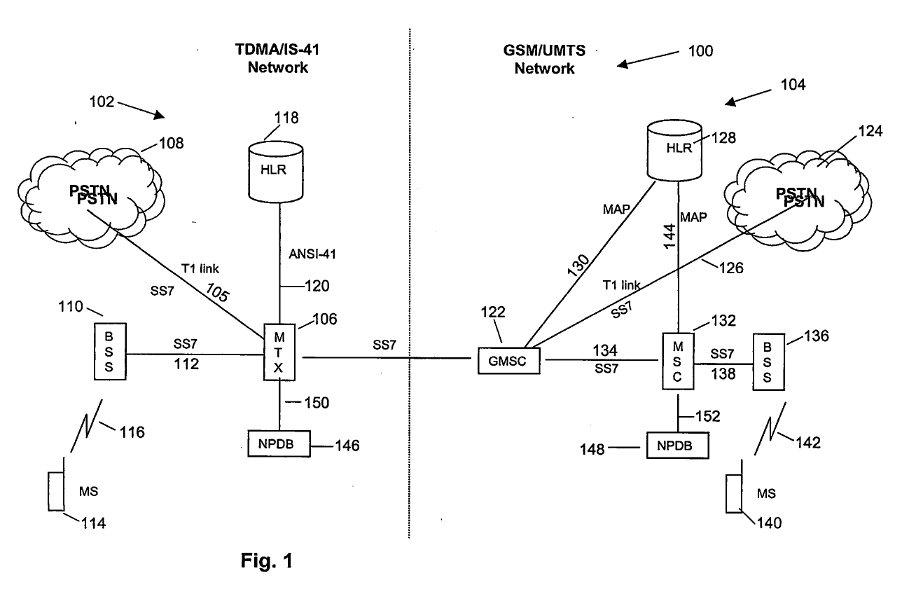

FIG. 1 illustrates the network architecture 100 of a current solution for providing the mobile number portability service in two communication networks based on two different generations of network technologies. The two independent networks illustrated are an IS41/TDMA network 102 and a GSM/UMTS network 104.

A T1 communications link 105 connects a mobile telephone exchange (“MTX”) 106 in the TDMA network 102 to a Public Switched Telephone Network 108 using SS7 protocol. As is well known in the art, the MTX 106 is in communication with a BSS 110 via a link 112 which also uses SS7 protocol. The BSS 110 may communicate with a number of mobile stations, such as mobile station 114 through a radio link 116. The MTX 106 is also in communication with a Home Location Register (“HLR”) 118 via a communications link 120 using an IS-41 protocol. The MTX 106 also communicates with a Gateway Mobile Switching Center (“GMSC”) 122 over a communications link 124 using a SS7 protocol.

The GMSC 122 is part of the GSM network 104. The GMSC 122 is in communication with a PSTN 124 (which could be identical to the PSTN 108) via a T1 link 126 using an SS7 protocol. The GMSC 122 is in communication with an HLR 128 via a communications link 130 using a MAP protocol. The GMSC 122 is also in communication with a Mobile Switching Center (“MSC”) 132 via a link 134 using an SS7 protocol. The MSC 132 is in communication with a BSS 136 via a communications link 138 using a SS7 protocol. The BSS 136 may be in communication with a number of mobile stations, such as mobile station 140 via a radio link 142. In this example, the MSC 132 is also in communication with the HLR 128 via a communications link 144 using a MAP protocol.

In this illustration, each network has a Number Portability DataBase (NPDB) center 146 and 148 respectively, where all the mobiles with ported numbers are registered. The NPDB 146 of the TDMA network 102 is in communication with the MTX 106 via a communications link 150. Similarly, the NPDB 148 of the GSM network 104 is in communication with the MSC 132 via a communications link 152. A ported mobile number is a mobile number that belongs to a subscriber of the current network who has moved its subscription to another network based on a different technology. For example, the NPDB 146 in the TDMA network 102 contains a list of mobile numbers which used to be TDMA subscribers and have now become GSM subscribers. These subscribers, however, are registered with the mobile phone number used in the TDMA network 102. Similarly, the NPDB 148 of the GSM network 104 contains a list of mobile numbers that used to be GSM subscribers, but have now become TDMA subscribers.

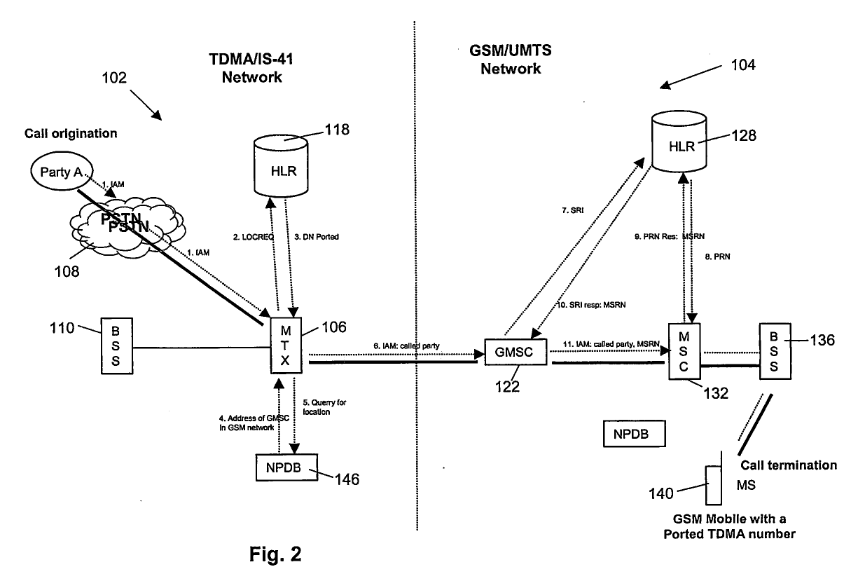

An operation example where a caller from the Public Switch Telephone Network (PSTN) calling a mobile in the GSM network with ported number from the TDMA network is shown in FIG. 2. In step 1, a PSTN caller Party A sends an Initial Address Message (IAM) to the PSTN network 108 which forwards it to the MTX 106 in the TDMA network 102. Given that the mobile number has not changed after moving its subscription to a GSM network, any incoming calls from PSTN will be routed to the MTX 106 located in the TDMA network.

In step 2, the MTX 106 will query HLR 118 for routing information by sending a Request, such as a Location Request (LocReq) message to the HLR 118. In response, the HLR 118 in step 3 sends a Location Request Response (LocReqResp) message to the MTX 106 indicating that the dialed number is a ported number to another network. The MTX 106 then sends a Query for Location message in step 4 to the NPDB center 146 asking for the location and identity of a Gateway MSC (GMSC) that is serving the mobile in his new network. In step 5, the NPDB center 146 sends to the MTX 106 the address of the GMSC in the new GSM network (for instance, GMSC 122). The MTX 106 then forwards the IAM message to the GMSC 122 (step 6). The GMSC 122 receives IAM message but without any routing information indicating which MSC should receive the call. As is known in the art, this routing information is stored and maintained at the HLR 128.

In step 7, the GMSC 122 sends a Send Routing Information (SRI) message to the HLR 128 requesting the routing number and address of the MSC serving the mobile. In step 8, the HLR 128 sends a Provide Routing Number (PRN) message to the MSC 132, which is serving the mobile. The PRN message asks for the routing number of the MSC 132. In step 9, the MSC 132 returns a Mobile Switching Routing Number (MSRN) to the HLR 128. The HLR 128 then forwards the routing number to the GMSC 122 in an SRI Response message (step 10). In step 11, the GMSC 122 forwards the IAM message to the MSC 132. At this point, the MSC 132 takes control and contacts the mobile 140 in its serving area via the BSS 136. The MSC 132 connects the mobile 140 with the PSTN calling Party A via the GMSC 122 in the GSM network and the MTX 106 in the TDMA network.

Using the above described solution, it can be seen that a total of 11 messages between core network entities are required in order for the call to reach the MSC serving the mobile 140 in the GSM network 104. In addition, changes and special provisioning to the TDMA HLR 118 are required in order to keep track of all the mobile numbers that have moved to another network. This requires an insertion of a record noting that the called mobile is no longer a TDMA subscriber and is now a ported number to the GSM network. This is considered as a waste of resources at the HLR 118 since the network operators would like to remove all records from the HLR 118 for subscribers that are no longer subscribers of the network of that HLR 118. Also, network operators want to introduce minimal changes to any network entity when adding the new number portability service.

Another disadvantage of such solution is that two independent NPDB entities are required, one for each network. This may cause a wireless service provider to incur higher operational and maintenance costs and longer deployment time for the number portability service.

An additional disadvantage with the above solution is that the GMSC 122 in the GSM network is involved in the call both during call setup procedure and after the call is setup. This may require the use of a communication port. Similar disadvantages and restrictions occur in all other scenarios such as when a PSTN caller calling a mobile in the TDMA network with ported number from the GSM network.

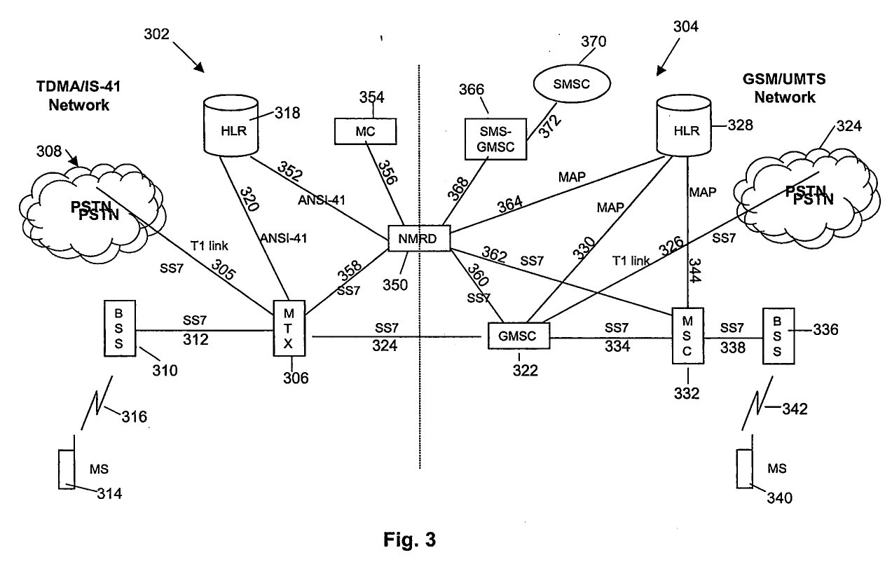

FIG. 3 illustrates the network architecture for mobile number portability solution utilizing one aspect of the present invention. In this illustration, the two independent networks are an IS41/TDMA network 302 and a GSM/UMTS network 304.

A T1 communications link 305 connects a mobile telephone exchange (“MTX”) 306 in the TDMA network 302 to a Public Switched Telephone Network 308 using SS7 protocol. As is well known in the art, the MTX 306 is in communication with a BSS 310 via a link 312 which also uses SS7 protocol. The BSS 310 may communicate with a number of mobile stations, such as mobile station 314 through a radio link 316. The MTX 306 is also in communication with a Home Location Register (“HLR”) 318 via a communications link 320 using an IS-41 protocol. The MIX 306 communicates with a Gateway Mobile Switching Center (“GMSC”) 322 over a communications link 324 using a SS7 protocol.

The GMSC 322 is part of the GSM network 304. The GMSC 322 is in communication with a PSTN 324 (which could be identical to the PSTN 308) via a T1 link 326 using an SS7 protocol. The GMSC 322 is in communication with an HLR 328 via a communications link 330 using a MAP protocol. The GMSC 322 is also in communication with a Mobile Switching Center (“MSC”) 332 via a link 334 using an SS7 protocol. The MSC 132 may be in communication with a BSS 336 via a communications link 338 using a SS7 protocol. The BSS 336 may be in communication with a number of mobile stations, such as mobile station 340 via a radio link 342. In this example, the MSC 332 is also in communication with the HLR 328 via a communications link 344 using a MAP protocol.

The network architecture illustrated in FIG. 3 introduces a Network Messaging and Routing Device (“NMRD”) 350. The NMRD 350 may be configured to communicate with a variety of network elements in both the TDMA network 302 and the GSM network 304 using the appropriate protocols. For instance, on the TDMA network side, the NMRD 350 communicates with the HLR 318 via a link 352 using an IS-41 protocol. The NMRD 350 may communicate with a message center (“MC”) 354 via a link 356 using an IS-41 protocol. The NMRD 350 may also communicate with the MTX 306 via a link 358 using an SS7 protocol.

On the GSM network side, the NMRD 350 may communicate with the GMSC 322 via a communications link 360 using a SS7 protocol. The NMRD 350 may communicate with the MSC 332 via a communications link 362 using a SS7 protocol. The NMRD 350 may communicate with the HLR 328 via a communications link 364 using a MAP protocol. Additionally, the NMRD 350 may be configured to communicate with the short message service gateway mobile switching center (“SMS-GMSC”) 366 via a communication link 368. The SMS-GMSC 366 communicates with a short message service center (“SMSC”) 370 via a communication link 372 in a manner well known in the art.

When used in the above network, the NMRD 350 acts as a TDMA/IS-41 to GSM MAP signaling gateway that translates the signaling messages from one protocol to another protocol, each protocol used specifically in different wireless network technology. In addition, the NMRD 350 maintains a database (not shown) that keeps track of all mobile numbers that are ported from one network technology to another.

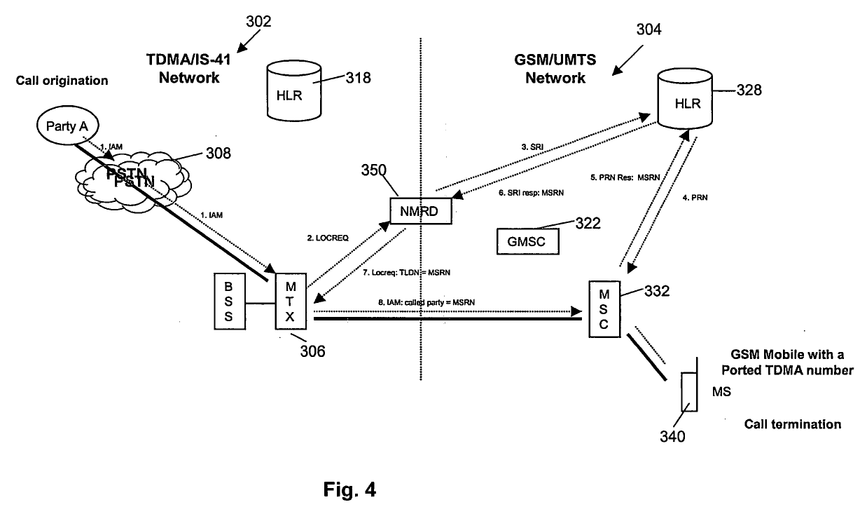

One operational feature of the architecture illustrated in FIG. 3, may be illustrated in FIG. 4. In this example, a “Party A” from the PSTN 308 is calling a mobile station 340 operating in the GSM network 304 and having a portable number from the TDMA network 302.

In step 1, the PSTN caller Party A sends an initiation message, such as Initial Address Message (IAM) to the PSTN network 308, which in turn, forwards the message to the MTX 306 in the TDMA network 302. Given that the mobile number has not changed after the user has moved the subscription to the GSM network 304, any incoming calls from PSTN will be routed to the MTX 306 located in the TDMA network 302 in a manner well known in the art. In step 2, the MTX 306 will query the NMRD 350 for routing information by sending a query message, such as Location Request (LOCREQ) message. After accessing the appropriate database, the NMRD 350 may determine that the called number is a mobile that was a TDMA network 302 subscriber, but has changed to a GSM network 304 subscriber. With the objective to find a MSC that is currently serving the mobile in the GSM network 304, the NMRD 350 queries the HLR 328 in the GSM network 304 in step 3. For instance, the NMRD 350 may send a Send Routing Information (“SRI”) message to the HLR 328 requesting the routing number and address for the MSC that is currently serving the mobile station 340. In step 4, the HLR 328 sends a response, such as a Provide Routing Number (“PRN”) message to the MSC 332 asking for its routing number. In step 5, the MSC 332 sends a response, such as a PRN Response containing a Mobile Switching Routing Number (“MSRN”) to the HLR 328. The HLR 328 forwards the routing number to the NMRD 350 in the SRI Response message (step 6). In step 7, the NMRD 350 sends a response back to the MTX 306, such as a LocReq Response message, which provides the routing information and the address of the MSC 332 in the GSM network.

Once the MTX 306 has the routing information, the MTX 306 may forward the IAM message to the MSC 332 in the GSM network 304 (step 8). At this point, the MSC 332 takes control and contacts the mobile in its serving area in a manner well known in the art. The MSC 332 then connects the mobile station 340 with the PSTN caller Party A via the MTX 306 in the TDMA network 302.

In comparison to the solution presented with reference to FIGS. 1 and 2, the above embodiment requires only 8 messages between the core network entities instead of the 11 required previously. Fewer messages leads to shorter call setup delay. In addition, the above embodiment does not use the HLR 318 in the TDMA network 302 or the GMSC 322 in the GSM network 304 to setup the call. Thus, the present embodiment does not require HLR provisioning, whereas the other solutions do.

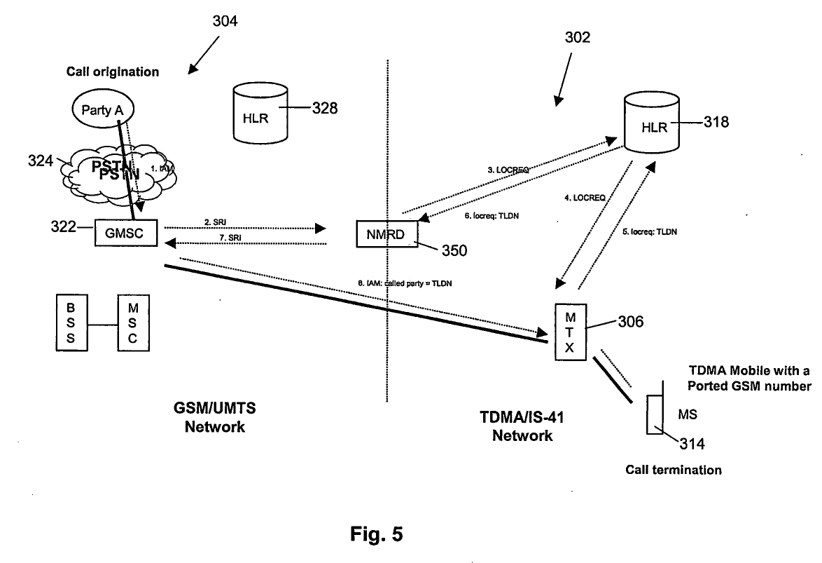

Another operational feature of the architecture illustrated in FIG. 3 may be illustrated in FIG. 5. In this example, a Party A from the PSTN 308 is calling a mobile station 314 operating in the TDMA network 302, but having a portable number from the GSM network 304.

In step 1, the PSTN caller Party A sends an initiation message, such as an Initial Address Message (IAM) to the PSTN network 324 which forwards the message to the GMSC 322 in the GSM network 304. Given that the mobile number has not changed after the user has moved the subscription to the TDMA network 304, any incoming calls from the PSTN 324 will be routed to the GMSC 322 in a manner well known in the art. In step 2, the GMSC 322 may query the NMRD 350 for routing information by sending a query message, such as a Send Routing Information (“SRI”) message. After accessing the appropriate database, the NMRD 350 may determine that the called number is a mobile that was a GSM network 304 subscriber, but has changed to a TDMA network 302 subscriber. With the objective to find a MTX that is currently serving the mobile 314 in the TDMA network 302, the NMRD 350 queries the HLR 318 in the TDMA network 302 in step 3. For instance, the NMRD 350 may send a Location Request (“LOCREQ”) message to the HLR 318 requesting the routing number and address for the MTX that is currently serving the mobile station 314. In step 4, the HLR 318 sends a message, such as a LOCREQ message to the MTX 306 asking for its routing number. In step 5, the MSC 332 sends a response, such as a locreq message to the HLR 318. The locreq response message may contain a TLDN, which is a temporary local directory number. The HLR 318 forwards the TLDN to the NMRD 350 in the locreq response message (step 6). In step 7, the NMRD 350 sends a response back to the GMSC 322, such as a SRI response message, which provides the TLDN.

Once the GMSC 322 has the TLDN, the GMSC may use this number to establish a voice path with the MTX 306. At this point, the MTX 306 takes control and contacts the mobile in its serving area in a manner well known in the art. The MTX 306 then connects the mobile station 314 with the PSTN calling Party A via the GMSC 322 in the GSM network 304.

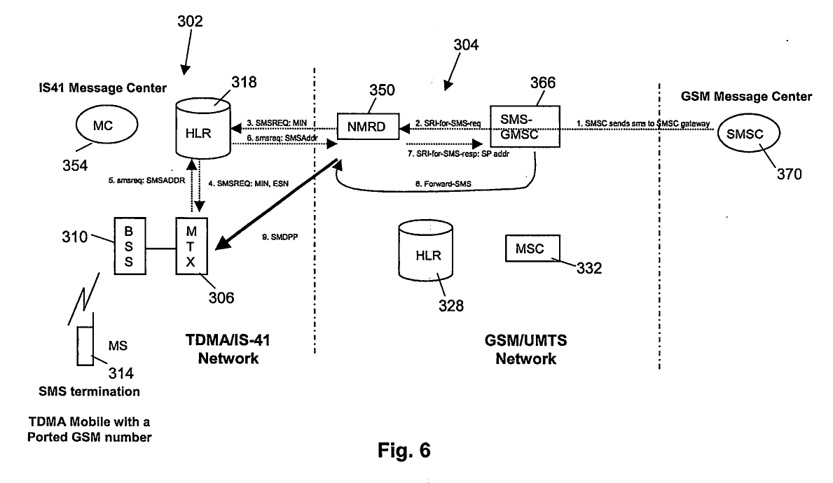

Another operational feature of the architecture illustrated in FIG. 3, may also be illustrated by FIG. 6. In this example, a GSM service center sends an SMS message to a TDMA mobile subscriber that has a ported GSM number.

In step 1, the SMSC 370 sends an SMS message to the SMSC gateway 366. In step 2, the SMCS gateway 366 sends a routing information request, such as a Send Routing Information message (e.g., “SRI-for-SMS-req”) to the NMRD 350. In response, the NMRD 350 will search its local database to locate the mobile number. In this situation, the NMRD 350 will determined that the mobile number is a TDMA subscriber with a GSM ported number. Based on this information, the NMRD 350 sends a request to the HLR 318, for example the request could be in the form of a SMS Request message (step 3). In step 4, the HLR 318 then will query the MTX 306 by sending, for instance, a SIMSREQ message to the MTX 306. In step 5, the MTX 306 may respond by sending back a message to the HLR 318, such as the smsreq: SMSADDR message. The HLR 318 then forwards the smsreq: SMSADDR message to the NMRD 350, which contains the address information (step 6). In step 7, the NMRD 350 asks the SMS-GMSC 366 to forward the SMS message to it by attaching in the SMS response message its Point Code address, by sending a SRI-for-SMS-resp: SP addr message. In response, the SMS-GMSC 366 forwards the SMS message to the NMRD 350 in step 8. At this moment, given that the GSM SMS message content is not compatible with the IS-41 SMS content formatting, the NMRD 350 will convert the message content from GSM to IS-41 format. The NMRD 350 then sends the message to the MTX 306 in step 9. The MTX then takes control and contacts the mobile in its serving area, then sends the mobile station the SMS message.

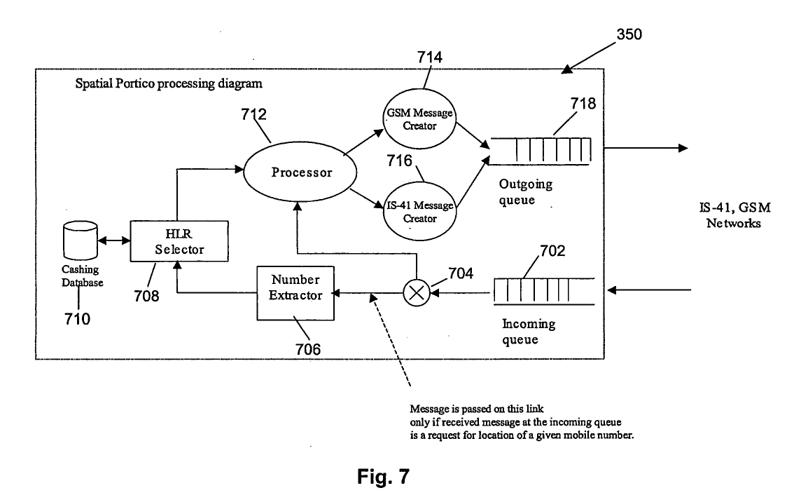

FIG. 7 illustrates one aspect of the processing occurring within the NMRD 350. Messages from the network are received by an incoming queue 702. The messages are separated with a filter 704 into two groups: (1) messages that request a location of a given mobile number, and (2) all other messages. If the message requests the location of a given mobile number, then the message flows to a number extractor 706. The number extractor extracts the MSISDN (Mobile Station ISDN number) from the message. Once the MSISDN number has been extracted, the MSISDN number and message is then sent to an HLR selector 708, which is coupled to a cashing database 710. As will be explained in more detail below, the HLR selector 708 uses the cashing database 710 to determine which type of HLR should address the message. After the HLR has been selected, the message, the number, and the address of the HLR are sent to the processor 712 for further processing. Similarly, messages that are not requests for a location of a given mobile number (e.g. group 2) are sent directly to the processor 712 from the filter 704. After the message has been processed, the processor determines the appropriate response. If the outgoing message is for a GSM network, then the response will be formulated into a GSM format using a GSM message creator 714. On the other hand, if the outgoing message is for an IS-41 network, then the response will be formulated into an IS-41 message using an IS-41 message creator 716. In either case, the formatted message then goes to the outgoing queue 718 for transmission.

In many cases, it is difficult to determine from the MSISDN if the requested location of a given MSISDN belongs to a GSM or an IS-41 network. To avoid querying both GSM HLR and IS-41 HLR, a cashing table or database may be used to identify the latest HLR type (GSM HLR or IS-41 HLR) that has successfully responded to location request service of a specific MSISDN. One illustrative format is presented in Table 1, below:

TABLE 1

| MSISDN | GSM/IS-41 HLR Flag |
|---|---|
| X | ON |
| Y | OFF |
| Z | ON |
| . . . | . . . |

The HLR Selector 708 uses the cashing table to select the first HLR for location request service. If the HLR flag is ON in the table, HLR Type is presumed to be GSM. If the first response is a failure, the NMRD 350 queries the other HLR and updates the Cashing table. The flag is turned off if the latest query to the GSM HLR fails to locate the mobile. Afterwards, the NMRD 350 will query the IS-41 HLR.

A new entry is created in the cashing table if the first HLR accessed for location information has failed, for example, if the response from HLR included unknown subscriber. At that time, the other type of HLR is queried for the mobile location information. If the returned result was successful (mobile is recognized by the HLR), a new entry is created in the cashing table. If the first time HLR query was a success based on the Global title number translation, no new entry is required in the cashing table. By following this strategy, the table size is minimized and will contain MSISDN for mobiles that have number portability activated.

An MSISDN entry is removed from the table if an error response is received from the GSM and the IS-41 HLR indicating “unknown subscriber” after querying both HLR types. Also, an entry can be added or removed from the table during provisioning and configuration of the NMRD 350. By using the cashing table information, chances of querying the wrong HLR on the first trial is minimized, hence obtaining the location information of the mobile in a shorter time.

The present disclosure as described above thus provides an economical method and system for supporting seamless mobile number portability between different wireless networks of different technologies. The solution is cost effective given that it does not introduce any changes to existing network entities in all wireless networks involved in the service.

In addition, the method and system disclosed herein has proved to require a minimal number of messaging between core network entities when compared to other solutions. This helps in reducing the call setup delay, hence better service performance from the user-end perspective. This also leads to no degradation in the quality and reliability of the services provided to the subscribers that are using ported numbers.

In addition, the disclosed method and system provides port and trunk savings at TDMA Gateway MSC or GSM Gateway MSC which lead to an increase of cost savings for the network operator. Also, the disclosed system does not require any provisioning of the HLR and has less functionality cost than legacy MTX or MSC. The present disclosure also introduces higher transmission savings with media gateway collocation with MTX.

Further, the present system requires only signaling to be handled at the NMRD. This means that higher scalability capacity can be achieved. The present system provides the number portability solution using a centralized NPDB located in the local database of the NMRD. This eliminates the requirement of adding an independent NPDB in each network, and any updates and maintenance can be done on the centralized NPDB location in the NMRD rather than over multiple NPDBs spread-out over the multiple networks.

In addition, the present disclosure provides cost-effective solutions for SMS service through integration of content conversion between the different network technologies and service transparency across the different networks of different technologies.

In addition, the present disclosure provides a maximum leverage of equipment investment since the configured networks are highly scalable and have a high reliability factor.

It will also be understood by those having skill in the art that one or more (including all) of the elements/steps of the present disclosure may be implemented using software and/or hardware to develop the NMRD network node, which may then be deployed in a wireless network at appropriate locations with the proper connections.

Furthermore, while the method and system has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A system for supporting seamless mobile number portability between at least two different wireless networks of different technologies, the system comprising:
a network messaging and routing device, the device being connected to the two networks and communicating to predetermined network elements in the two networks using predetermined protocols understood by each network; and
a database operable with the network messaging and routing device for maintaining records of a plurality of mobile numbers that are ported from a first network to a second network,
wherein, through the network messaging and routing device, a mobile user maintains his assigned mobile number after he changes his subscription from the first network to the second network,
wherein no changes to existing network entities are needed for implementing communications between the entities to the network messaging and routing device.

2. A network architecture for supporting mobile number portability between at least two different wireless networks of different a first technology and a second technology, the architecture comprising:
a networking messaging and routing device,
a first location register compatible with the first technology in communication with the networking messaging and routing device,
a second location register compatible with the second technology in communication with the networking messaging and routing device,
a mobile telephone exchange compatible with the first technology in communication with the networking messaging and routing device and the first location register,
a mobile switching center compatible with the second technology in communication with the networking messaging and routing device and the second icoation register.

3. The network architecture of claim 2 wherein the network messaging and routing device has logic for:
receiving incoming messages,
extracting an ISDN number from the message,
selecting a home location register,
processing the message,
converting the message to the appropriate format, and
forwarding the message.

4. A method of connecting a call to a mobile station having a number from a first network using a first technology which has been ported to a second network using a second technology, the method comprising:
receiving a initiation message at a mobile telephone exchange compatible with the first technology, wherein the initiation message contains a number associated with the mobile station,
querying a network messaging and routing device to determine whether the number is a ported number and to determine an address of the mobile switching center compatible with the second technology and in communication with the mobile station,
routing the initiation message to the mobile switching center, and
connecting the call to the mobile station.

5. The method of claim 4, wherein the querying comprises:
receiving a location register request,
querying a home location register for a mobile switching routing number,
receiving a mobile switching routing number, and
sending the mobile switching routing number in response to the receiving.

6. The method of claim 5, further comprising:
sending a routing number request to a mobile switching center, and
receiving the mobile switching routing number from the mobile switching center.

7. A method of connecting a call to a mobile station having a number from a first network using a first technology which has been ported to a second network using a second technology, the method comprising:
receiving a initiation message at a gateway mobile switching center compatible with the first technology, wherein the initiation message contains a number associated with the mobile station,
querying a network messaging and routing device to determine whether the number is a ported number and to determine a temporary number for the mobile telephone exchange compatible with the second technology and in communication with the mobile station,
routing the initiation message to the mobile telephone exchange, and
connecting the call to the mobile station.

8. The method of claim 7, wherein the querying comprises:
receiving a routing request,
querying a home location register for a temporary number for mobile telephone exchange,
receiving the temporary number, and
sending the temporary number in response to the receiving.

9. The method of claim 8, further comprising:
sending a location request to a mobile telephone exchange, and
receiving a temporary number for the mobile telephone exchange.

10. A method of sending short message service messages to a mobile station having a number from a first network using a first technology which has been ported to a second network using a second technology, the method comprising:
receiving a short message service message from a short message service center, addressed to the mobile station,
querying a network messaging and routing device to determine whether the number is a ported number and to determine the short message service address for the mobile telephone exchange in communication with the mobile station,
routing the short message service message to the network messaging and routing device,
converting the short message service message to a form compatible with the second technology, and
sending the converted short message to a mobile telephone exchange for forwarding on to the mobile station.

11. The method of claim 10, wherein the querying comprises:
receiving a routing request at a home location register from a network messaging and routing device,
sending a address request to a mobile telephone exchange,
receiving a short message service address from the telephone exchange, and
sending the short message service address to the network messaging and routing device.
